(19) United States
(12) Patent Application Publication
(10) Pub. No.: US 2024/0070496 A1
(43) Pub. Date: Feb. 29, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Kento KOTERA, Kawasaki (JP); Akihiro YAMAGUCHI, Kita (JP); Ken UENO, Tachikawa (JP)

(73) Assignee: KABUSHIKI KAISHA TOSHIBA, Tokyo (JP)

(21) Appl. No.: 18/174,190

(22) Filed: Feb. 24, 2023

(30) Foreign Application Priority Data
Aug. 31, 2022 (JP) 2022-138164

(51) Int. Cl. G06N 7/01

(52) U.S. Cl. CPC G06N 7/01

(57) ABSTRACT

An information processing device incudes one or more hardware processors. The processors calculate first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and determine a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

### CROSS-REFERENCE TO RELATED APPLICATIONS

This application is based upon and claims the benefit of priority from Japanese Patent Application No. 2022-138164, filed on Aug. 31, 2022; the entire contents of which are incorporated herein by reference.

### FIELD

Embodiments described herein relate generally to an information processing device, an information processing method, and a computer program product.

### BACKGROUND

In technologies for detecting states of anomalies and the like in time series data such as industrial data and biological data, it is required not only to detect states (anomalies) but also to clarify the basis for determining the states (anomalies).

### BRIEF DESCRIPTION OF THE DRAWINGS

FIG. 1 illustrates graphs for describing examples of anomaly detection when fluctuations are not taken into account;

FIG. 2 illustrates graphs for describing examples of anomaly detection when fluctuations are taken into account;

FIG. 3 is a block diagram of an information processing device according to a first embodiment;

FIG. 4 is a flowchart illustrating learning processing according to the first embodiment;

FIG. 5 is a flowchart illustrating diagnosis processing according to the first embodiment;

FIG. 6 is a chart illustrating an example of output information;

FIG. 7 is a block diagram of an information processing device according to a second embodiment;

FIG. 8 is a flowchart illustrating learning processing according to the second embodiment; and

FIG. 9 is a hardware configuration diagram of the information processing devices according to the embodiments.

### DETAILED DESCRIPTION

According to an embodiment, an information processing device includes one or more hardware processors. The hardware processors calculate first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis. The hardware processors determine a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

With reference to the accompanying drawings, preferable embodiments of an information processing device according to embodiments will be described in detail hereinafter. Hereinafter, a case of detecting an anomaly as a state of time series data will be described as an example. The states to be detected are not limited to anomalies, but may be any state.

In time series data to be a target of anomaly detection, there may be areas with a large fluctuation and a small fluctuation even in normal time series data. In a conventional anomaly detection technology using partial time series, the magnitude of fluctuation is not reflected upon the calculation of anomaly severity, which may result in overestimating the difference with respect to the partial time series with a large fluctuation and underestimating the difference with respect to the partial time series with a small fluctuation in some cases.

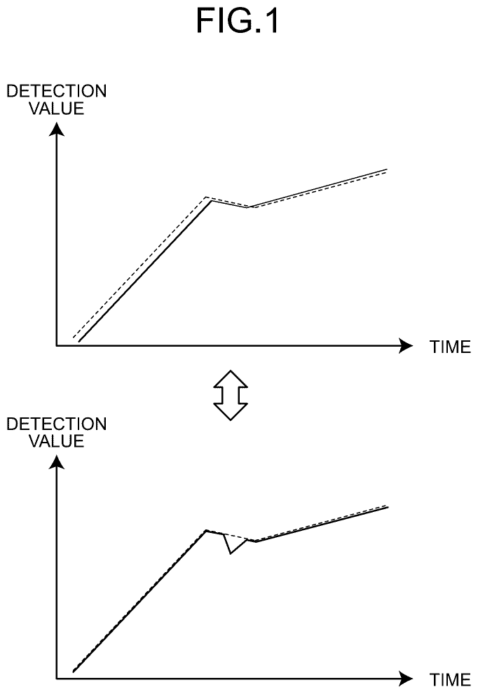

FIG. 1 illustrates graphs for describing examples of anomaly detection when fluctuations are not taken into account. In the graphs in FIG. 1, data with a dotted line indicates an example of time series data (data indicating changes in detection values over time) under a normal state. Data with a solid line indicates an example of time series data to be a target of diagnosis. The top graph corresponds to an example where there is a small overall difference between the two. The bottom graph corresponds to an example of a case where there is a point with a large difference in the center, and there is almost no difference between the two in other points.

When fluctuations are not taken into account, the time series data of the bottom graph including a point with a large difference is diagnosed to have an anomaly, and the time series data of the top graph including points with only small differences is diagnosed to have no anomaly, for example. However, there may be cases where it should not to be determined as having an anomaly even when the center corresponds to a point with a large fluctuation and the difference is large, for example. On the other hand, there may be cases where it needs to be determined as having an anomaly even when points other than the center correspond to points with small fluctuations and the differences are small, for example.

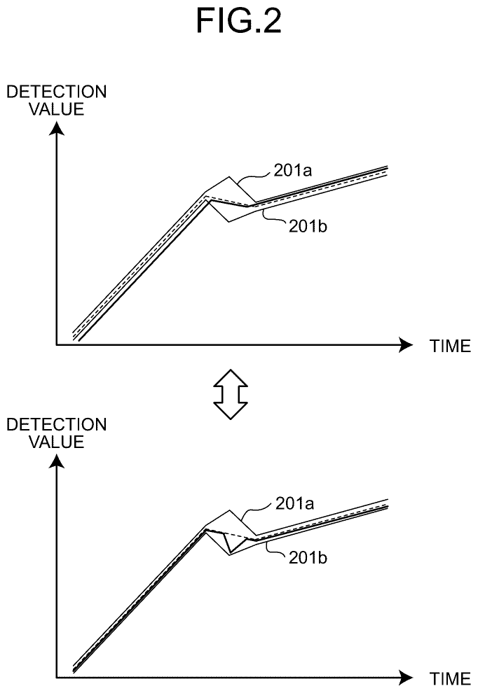

Therefore, the following embodiments are configured to allow anomaly diagnosis by taking into account a fluctuation of a value, at each time point, of time series data. FIG. 2 illustrates graphs for describing examples of anomaly detection when fluctuations are taken into account.

Lines 201a and 201b in FIG. 2 are lines used to indicate the upper limit and the lower limit of fluctuations, respectively. It means that, at each time, there is a fluctuation ranging from the lower limit indicating a value at the time on the line 201b to the upper limit indicating a value at the time on the line 201a. For example, in a case where a difference within the fluctuation range is not determined as an anomaly and a difference exceeding the fluctuation range is determined as an anomaly, the top graph is determined as having an anomaly since there is a difference exceeding the fluctuation range at points in the early time. The bottom graph is not determined as having an anomaly, since the differences at any time are within the fluctuation range.

### First Embodiment

An information processing device according to the first embodiment detects anomalies by taking into account fluctuations of partial time series contained in time series data to be a target of diagnosis (hereinafter, referred to as “target time series data”). For example, the information processing device according to the present embodiment has the following functions.

(F1) Function of learning various partial time series patterns of a group of similar time series data as a probabilistic model group.

(F2) Function of calculating the similarity between partial time series (partial time series data) of the target time series data and a probabilistic model.

(F3) Function of referring to the similarity between the probabilistic model group and the partial time series data group within a certain range on the target time series data, and determining a probabilistic model and partial time series data at a position where the similarity is larger than other probabilistic models (for example, is the maximum).

(F4) Function of detecting anomalies based on the similarity between the target time series data and the probabilistic model group.

The target time series data is defined to be time series data with a single variable (univariate). Examples of the target time series data may be sensor data acquired by sensors that detect physical quantities such as current and pressure of a certain device, and biological signal data such as ElectroCardioGram (ECG) and ElectroEncephaloGram (EEG). Note that the target time series data is not limited to those, but may be any kind of time series data.

Sensor data may be the detection values themselves of a sensor, statistical values of the detection values (mean, maximum, minimum, standard deviation, and the like.), or calculated values of the detection values of a plurality of sensors of the same or different types (for example, power acquired by multiplying current and voltage).

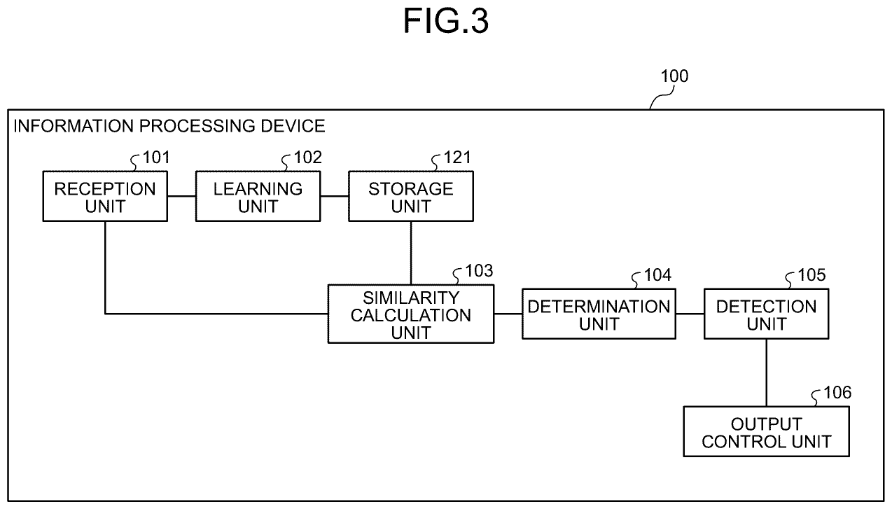

FIG. 3 is a block diagram illustrating an example of a configuration of an information processing device 100 according to the first embodiment. As illustrated in FIG. 3, the information processing device 100 includes a reception unit 101, a learning unit 102, a similarity calculation unit 103, a determination unit 104, a detection unit 105, an output control unit 106, and a storage unit 121.

The information processing device 100 has two operation phases that are a learning phase and a diagnosis phase. In the learning phase, a plurality of probabilistic models (a probabilistic model group), which probabilistically model a plurality of representative partial time series patterns from a group of similar time series data, are trained. In the diagnosis phase, anomaly diagnosis is performed on the target time series data by using the trained probabilistic model group.

In the learning phase, the reception unit 101, the learning unit 102, and the storage unit 121 are mainly used. In the diagnosis phase, the reception unit 101, the similarity calculation unit 103, the determination unit 104, the detection unit 105, and the output control unit 106 are mainly used.

The reception unit 101 receives input of various kinds of data used in the information processing device 100. For example, the reception unit 101 receives input of learning data used by the learning unit 102 for learning, target time series data, and the like.

The learning unit 102 trains a plurality of probabilistic models by using a plurality of pieces of time series data (time series data group) input as learning data ((F1) described above). For example, the learning unit 102 trains a plurality of probabilistic models by using a plurality of pieces of time series data for learning. By the training, probabilistic models each modeling the probability of a value, at corresponding time, of time series data where the data length is a specific value L can be acquired. For example, each probabilistic model is a multidimensional probability distribution model that is defined using the mean and variance, where L is the number of dimensions. The data length represents the length of the time series data, which is the number of elements contained in the time series data, for example. In a case where each element is acquired at regular intervals, the data length may be expressed in terms of time length.

The storage unit 121 stores therein various kinds of data used in the information processing device 100. For example, the storage unit 121 stores therein data received by the reception unit 101 and data related to the probabilistic model trained by the learning unit 102.

Note that the storage unit 121 may be configured with any commonly used storage medium such as a flash memory, a memory card, a Random Access Memory (RAM), a Hard Disk Drive (HDD), and an optical disc.

The similarity calculation unit 103 calculates the similarity (a first similarity) between a plurality of probabilistic models acquired in the learning phase and a plurality of pieces of partial time series data contained in the target time series data ((F2) described above). For example, the similarity calculation unit 103 calculates the similarity between each of the probabilistic models and the pieces of partial time series data with the data length L contained in the target time series data.

The determination unit 104 repeatedly executes processing of collating (matching) the most similar probabilistic model with the partial time series data until the partial time series data covers (goes over) the entire target time series data. The determination unit 104 determines and outputs, as information indicating the matching results, a plurality of pieces of matching information including the position of the partial time series data within the target time series data, the probabilistic model (a first probabilistic model) whose similarity with the partial time series data at that position is greater than the other probabilistic models, and the similarity to the first probabilistic model. Note that “the similarity is greater than the other probabilistic models” means that the similarity is the maximum, for example. Hereinafter, a case where the similarity is the maximum will be described as an example.

For example, the determination unit 104 obtains the partial time series data that has the maximum similarity with any of the probabilistic models among the pieces of partial time series data starting from each of a plurality of positions included in a range from a position set immediately before to a specific value. The determination unit 104 determines the matching information that includes the obtained partial time series data, the probabilistic model whose similarity with the obtained partial time series data is the maximum, and the maximum similarity. The determination unit 104 executes such processing repeatedly a plurality of times such that the determined partial time series data covers the entire target time series data, and outputs a plurality of pieces of matching information.

The processing performed by the determination unit 104 can be interpreted as the processing for sequentially determining a plurality of probabilistic models that best fit the target time series data, among the various patterns of probabilistic models acquired in advance ((F3) described above).

The detection unit 105 detects anomalies of the target time series data by using a plurality of similarities included in the pieces of matching information ((F4) described above). For example, the detection unit 105 detects that there is an anomaly in the target time series data when the minimum value of the similarities is smaller than a threshold.

The output control unit 106 controls output of various kinds of data used in the information processing device 100. For example, the output control unit 106 outputs the detection results acquired by the detection unit 105. The output control unit 106 may output the output information that includes a normal range in which the time series data is assumed to be normal. The normal range can be obtained by using the mean and variance of the probabilistic model, for example.

The output method of the output control unit 106 may be any method, and it is possible to apply, for example, a method of displaying on a display device such as a liquid crystal display, a method of outputting to a recording medium using an image forming device such as a printer, and a method of transmitting data to an external device (a server, other information processing device, or the like).

Each of the above units (the reception unit 101, the learning unit 102, the similarity calculation unit 103, the determination unit 104, the detection unit 105, and the output control unit 106) is achieved by one or more hardware processors, for example. For example, each of the above units may be achieved by having a processor such as a central processing unit (CPU) execute a program, that is, by software. Each of the above units may be achieved by a dedicated integrated circuit (IC), that is, by hardware. Each of the above units may be achieved by using a combination of software and hardware. When using a plurality of processors, each of the processors may achieve one of the units or may achieve two or more of the units.

Each of the above units may be provided in a distributed manner among a plurality of physically different devices. For example, the components used in the learning phase (the reception unit 101, the learning unit 102, the storage unit 121, and the like) and the components used in the diagnosis phase (the reception unit 101, the similarity calculation unit 103, the determination unit 104, the detection unit 105, the output control unit 106, the storage unit 121, and the like) may be provided to mutually different devices (two servers or the like). Some or all of the above units may be provided on a server built on a cloud environment.

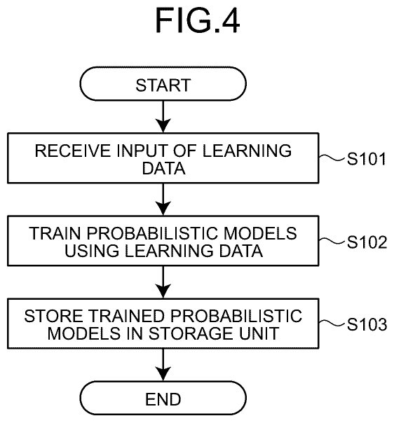

Next, learning processing performed by the information processing device 100 according to the first embodiment will be described. The learning processing is processing executed in the learning phase. FIG. 4 is a flowchart illustrating an example of the learning processing according to the first embodiment.

The reception unit 101 receives input of learning data from an external device or the like (step S101). The learning data is a time series data group X that is a set of similar time series data, for example. The time series data group X does not have any teacher information such as a normal label and an anomaly label. The time series data group X contains N-pieces of univariate time series data x. Each of the pieces of time series data x has a data length of T. In other words, each time series data x contains T points. Each element of each of the pieces of time series data x is defined as x₁, . . . , xT.

The learning unit 102 receives the time series data group X and trains K probabilistic models M that probabilistically model the patterns of the partial time series data with the data length L contained in the time series data group X (step S102). Note that K is designated in advance as the number of probabilistic models M to be obtained by training, for example.

Hereinafter, individual probabilistic models are denoted as Mₖ (k=1, . . . , K). The probabilistic model Mₖ is expressed by a multidimensional probability distribution with the number of dimensions equal to the data length L of the partial time series data. In the present embodiment, a normal distribution is assumed with p being the mean and being the covariance matrix. Note, however, that each dimension of the mean p and the covariance matrix corresponds to each data point in the partial time series data. Each data point, that is, each dimension, is independent, and the covariance matrix Σ is a diagonal matrix. In other words, the probabilistic model M is trained to be a multidimensional probability distribution where each dimension (each data point) is independent, the covariance matrix Σ is a diagonal matrix, and the number of dimensions is L.

The method of training may be any method that can train the probabilistic model M as described above from the time series data group X. For example, the learning unit 102 may use a machine learning method such as Gaussian mixture model clustering, or a combination of k-means method, statistical method, and optimization method. Furthermore, the probabilistic model is not limited to a normal distribution, but other probability distributions such as an exponential distribution may be used.

The learning unit 102 stores the trained K probabilistic models in the storage unit 121 (step S103), and ends the learning processing.

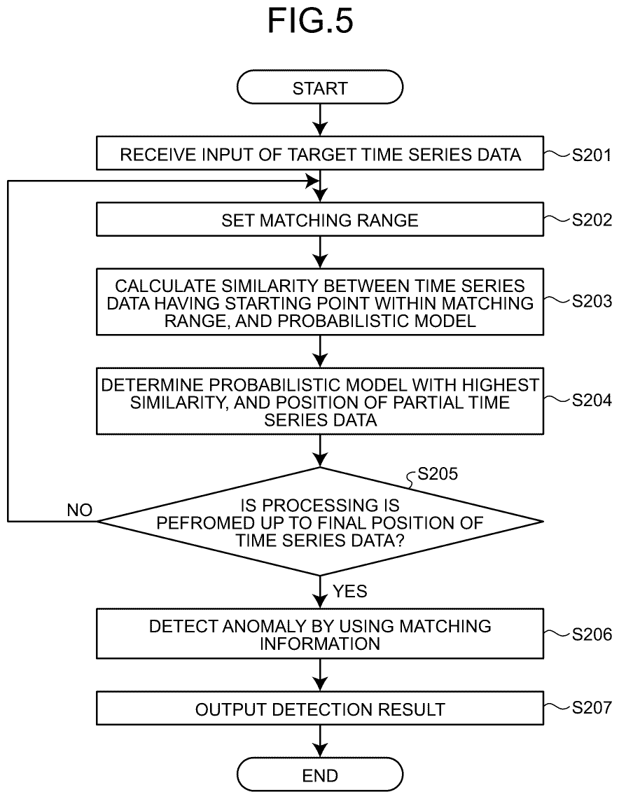

Next, diagnosis processing performed by the information processing device 100 according to the first embodiment will be described. The diagnosis processing is processing performed in the diagnosis phase. FIG. 5 is a flowchart illustrating an example of the diagnosis processing according to the first embodiment.

The reception unit 101 receives input of the target time series data x from an external device or the like (step S201). The target time series data x is the same type of data with the data length T equal to that of the time series data group X used as the learning data.

The similarity calculation unit 103 sets a matching range (step S202). The matching range indicates a certain range that is defined as the range that includes the starting point of the partial time series data to be the target of the similarity calculation with respect to the probabilistic model. The matching range is set, for example, as the range from the position (matching position) set immediately before to the data length L. The matching position indicates the position of the starting point of the partial time series data that is obtained, in the iterative processing performed immediately before, as the partial time series data whose similarity with any of the probabilistic models is the maximum. In the first iterative processing, only the beginning of the target time series data is set as the matching range.

The flow of the iterative processing in the present embodiment is similar to the flow of the fitting processing described in Japanese Patent No. 6877245, for example. The fitting processing does not use a probabilistic model that models the probability of a value, at each time, of time series data, which is different from the present embodiment.

The similarity calculation unit 103 calculates the similarities between one or more pieces of partial time series data contained in the target time series data x and having starting pints within the matching range, and the probabilistic models in the probabilistic model group (step S203).

In the following, partial time series data from the i-th point to the (i+L−1)th point of the target time series data x is denoted as x_{(i,i+L-1)}=(xᵢ, . . . , x_{i+L-1}). Furthermore, the similarity between x_{(i, i+L)} and the k-th (1≤k≤K) probabilistic model Mₖ is denoted as D_{i, k}.

In the first iterative processing, the similarity calculation unit 103 calculates K similarities (a similarity group) D_{1, 1} . . . , D_{1, K} between respective pieces of partial time series data x_{(1,L)}=(x₁, . . . , x_{L}) from the 1st to the L-th point of the target time series data x and K pieces of probabilistic models M₁, . . . , M_{K}.

The similarity may be any information that indicates the degree of similarity between the partial time series data and the probabilistic model. For example, the similarity calculation unit 103 may calculate, as the similarity, a value based on the distance in a probability distribution, such as the Kullback-Leibler distance and the Pearson distance.

The similarity calculation unit 103 may extend the partial time series data to a probabilistic model, and calculate a value based on the distance between the extended probabilistic model and the probabilistic models Mₖ as the similarity. For example, when using the Kullback-Leibler distance, the similarity calculation unit 103 extends the partial time series data x(1, L) to a probability distribution P=N(x_{(i,i+L-1)}, Σₖ), where the partial time series data x_{(i, i+L-1)} and the covariance matrix Σₖ are parameters. The similarity calculation unit 103 calculates the Kullback-Leibler distance KL(P, Q) between the extended probability distribution (an example of the probabilistic model) and a probability distribution Q=N(x_{(i,i+L-1)}, Σₖ) indicated by the probabilistic model Mₖ.

As for the Kullback-Leibler distance, it means that the larger the value, the smaller the similarity. Therefore, the similarity calculation unit 103 uses, as the similarity, the value acquired by an operation to find the reciprocal of the Kullback-Leibler distance, by an operation to convert the Kullback-Leibler distance to a negative value and input it into an exponential function with the Napier's constant as the base, or the like.

The similarity calculation unit 103 may calculate the similarity by a method using the log-likelihood without using the distance in the probability distribution. For example, assuming that a probability density function of a multivariate normal distribution having the mean μ and the covariance matrix Σ as parameters is f(x|μ, Σ), the similarity calculation unit 103 can calculate the similarity between the partial time series data x_{(i,i+L-1)} and the model M_{K} as log f(x_{(i, i+L-1)}|μ, Σ).

The determination unit 104 determines the probabilistic model with the maximum similarity and the position (matching position) of the partial time series data, and outputs matching information that includes the partial time series data starting from the determined position, the probabilistic model having the maximum similarity with respect to the partial time series data, and the maximum similarity (step S204). For example, the determination unit 104 first selects the maximum similarity among a group of calculated similarities D_{1,1} . . . , D_{1, K}. The probabilistic model with the maximum similarity means the model that is closest to the target time series data x. The determination unit 104 outputs the matching information to the similarity calculation unit 103 and the detection unit 105. Note that the matching position is 1 in the first iterative processing.

The determination unit 104 determines whether processing it performed up to the final position of the target time series data (step S205). For example, when the matching position comes to the (T-L)-th point of the target time series data, the determination unit 104 determines that processing is preformed to the final position. This determination corresponds to determining whether the processing of matching the partial time series data with the most similar probabilistic model is performed until the partial time series data covers the entire target time series data.

When the processing is not preformed up to the final position of the target time series data (No at step S205), the processing returns to step S202 and is repeated by setting a next matching range. The second iterative processing and thereafter will be executed as follows, for example.

The similarity calculation unit 103 refers to the matching position output immediately before by the determination unit 104, and sets a matching range. Assuming that the matching position output immediately before is j, the range from j+1 to the position where the data length L is added is set as the matching range (step S202).

The similarity calculation unit 103 calculates the similarity for all combinations of a group of L-pieces of partial time series data x_{(j+1, j+L)}, . . . x_{(j+L,j+2L-1)} in the target time series data x with certain points in the matching range being the starting points (start positions) and a group of K probabilistic models M₁, . . . , M_{K} (step S203). As a result, L×K similarities are calculated.

However, in a case where j+2L exceeds the time series length T of x, the similarity calculation unit 103 calculates the similarity group for all combinations of the group of partial time series data x_{(i+1, j+1+L)}, . . . , x_{(T-L, T)} and the group of K probabilistic models M₁, . . . , M_{K}.

The determination unit 104 determines the maximum similarity among the calculated similarity group D_{i,k} (i=j+1, . . . , j+L, k=1, . . . , K), and outputs the matching information (step S204).

When it is determined at step S205 that the processing is preformed up to the final position of the target time series data (Yes at step S205), the detection unit 105 refers to the matching series and detects whether there is an anomaly in the target time series data (step S206). The matching series is, for example, the information in which pieces of matching information output up to that point are arranged in order.

For example, the detection unit 105 calculates the anomaly level from the matching series. The anomaly level may be, for example, a statistic value regarding a plurality of similarities (similarity sequence) contained in the matching series, or may be a value acquired by performing an operation on the similarities. The statistic value is, for example, the minimum value among the similarities, the maximum value among the similarities, or the mean value of the similarities. The detection unit 105 determines as an anomaly, when the calculated anomaly level is smaller than a threshold defined in advance.

The output control unit 106 outputs the result of anomaly detection (step S207). The output control unit 106 may output only the determination result indicating whether it is normal or anomalous, or may output information based on the matching information in addition to the determination result. For example, in a case where the minimum value among the similarities is used as the anomaly level, the output control unit 106 outputs, as an anomaly point, the matching position corresponding to the similarity that takes the minimum value among the matching positions included in the matching information.

As described above, the output control unit 106 may output the output information including a normal range. For example, in a case where the probabilistic model is a normal distribution, the output control unit 106 defines a normal range, having a value acquired by subtracting p times (p is a real number greater than 0) the diagonal components (σ²₁, . . . , σ²_{L}) of the covariance matrix Σ from the mean value parameter μ of the probabilistic model as the lower limit of the normal range, and having a value acquired by adding p times the diagonal components (σ²₁, . . . , σ²_{L}) of the covariance matrix to the mean value parameter p as the upper limit of the normal range. The output control unit 106 outputs the normal range in the target time series data x on the basis of the matching position included in the matching information. This makes it possible for the output control unit 106 to output information including the normal range as the basis for determining an anomaly.

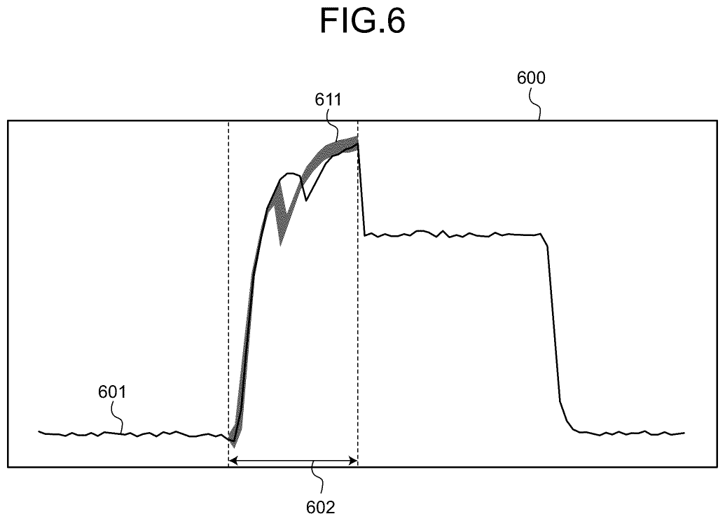

FIG. 6 is a chart illustrating an example of output information 600 to be output. As illustrated in FIG. 6, the output information 600 includes target time series data 601, matching positions 602 including anomaly points, and a normal range 611. Note that the target time series data 601 is data, taking time in the right direction and values in the upward direction. The normal range 611 corresponds to a range bounded by the lower limit taken in the upward direction and the lower limit taken in the downward direction, centered on the value, at each time, of the target time series data 601.

In this manner, the first embodiment detects anomalies of the target time series data to be the target of diagnosis by using the probabilistic model that takes into account a fluctuation at each time point in the time series data. This makes it possible to execute anomaly detection based on the time series data with higher accuracy.

### Second Embodiment

An information processing device according to a second embodiment further takes into account a chain model that models a chain pattern representing the characteristic of the occurrence order of the probabilistic models. For example, the information processing device of the present embodiment is additionally provided with a function of training the chain model and a function of calculating the similarity by also taking the chain model into account.

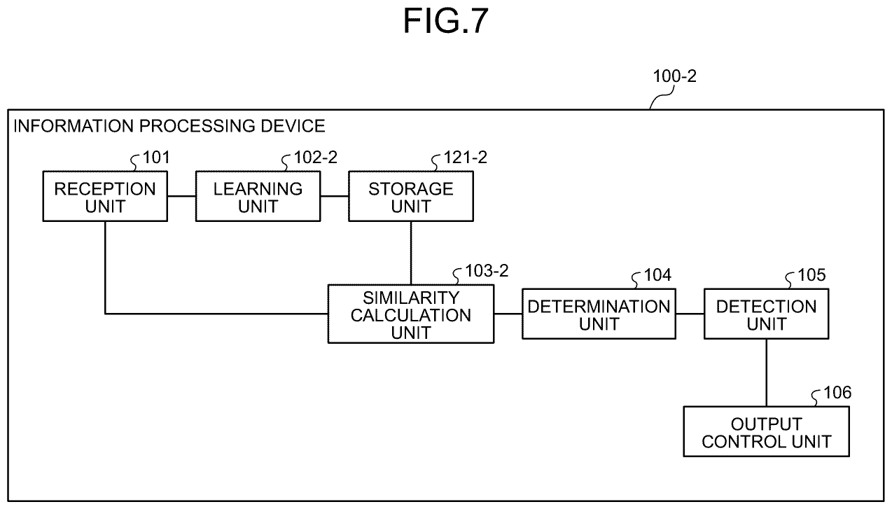

FIG. 7 is a block diagram illustrating an example of a configuration of an information processing device 100-2 according to the second embodiment. As illustrated in FIG. 7, the information processing device 100-2 includes a reception unit 101, a learning unit 102-2, a similarity calculation unit 103-2, a determination unit 104, a detection unit 105, an output control unit 106, and a storage unit 121-2.

In the second embodiment, the functions of the learning unit 102-2, the similarity calculation unit 103-2, and the storage unit 121-2 are different from those in the first embodiment. Other configurations and functions are the same as in FIG. 3 that is a block diagram of the information processing device 100 according to the first embodiment, so the same reference signs are applied and the explanations are omitted herein.

The learning unit 102-2 is different from the learning unit 102 of the first embodiment in respect that it further has a function of training the chain model. For example, the learning unit 102-2 models the probability of the occurrence of an probabilistic model MB after a given probabilistic model MA as a discrete distribution (for example, a categorical distribution), and performs training by Bayesian inference. The method for training the chain model is not limited thereto, but any method may be used as long as the method is to model a pattern of the occurrence order of the probabilistic models and perform training.

The similarity calculation unit 103-2 is different from the similarity calculation unit 103 of the first embodiment in respect that it takes into account the similarity with respect to the chain model when calculating the similarity. The similarity to the chain model is calculated independently of the similarity with respect to the probabilistic model. For example, the similarity between the partial time series data and the chain model is the likelihood with respect to the chain model.

The similarity calculation unit 103-2 calculates a similarity SA (a first similarity) between the partial time series data and the probabilistic model in the following manner, for example. First, for each piece of partial time series data DA (first data) contained in a group of L-pieces of partial time series data, the similarity calculation unit 103-2 calculates a similarity SB (a second similarity) with respect to a plurality of probabilistic models. Furthermore, the similarity calculation unit 103-2 refers to the probabilistic model output from the matching information immediately before and calculates, as a similarity SC (a third similarity), the likelihood regarding the chain model when the probabilistic models match the chain model. For example, assuming that the probabilistic model matched immediately before is Mₖ₁ and the probabilistic model to be the target of calculation is Mₖ₂, the value of conditional probability p(Mₖ₂|Mₖ₁) (or its logarithm) is used as the likelihood. In the first case of a loop with no probabilistic model matched immediately before, an unconditional probability p(Mₖ₂) or the like is used as the likelihood. Then, the similarity calculation unit 103-2 calculates the similarity SA by an operation using the similarity SB and the similarity SC. The operation herein may be any operation, such as addition, weighted addition, and multiplication.

The storage unit 121-2 further stores therein data related to the chain model learned by the learning unit 102-2.

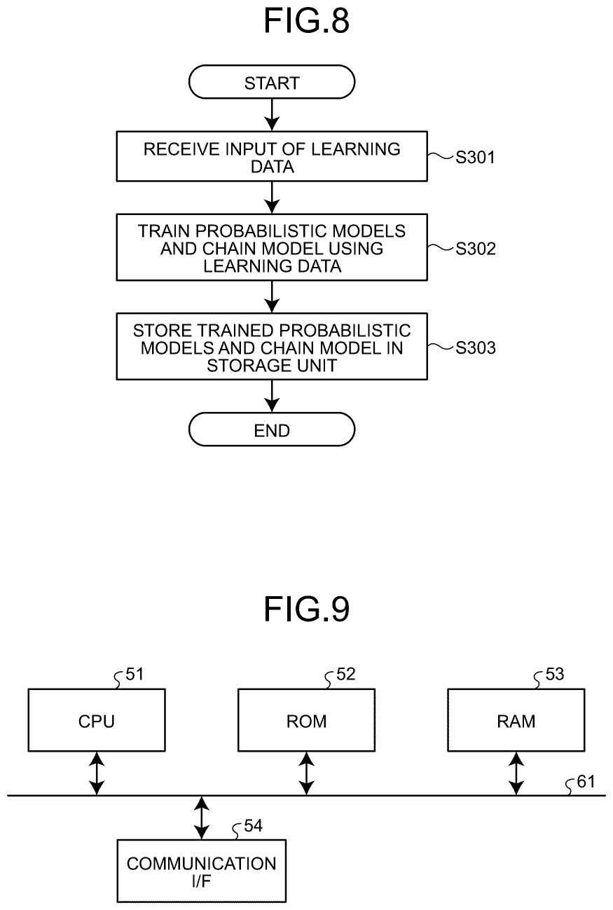

Next, learning processing performed by the information processing device 100-2 according to the second embodiment will be described by referring to FIG. 8. FIG. 8 is a flowchart illustrating an example of the learning processing according to the second embodiment.

Step S301 is the processing same as step S101 of the information processing device 100 according to the first embodiment, so the explanation thereof is omitted.

The learning unit 102-2 first trains the K probabilistic models M using the time series data group X by the same procedure as in the first embodiment. Thereafter, the learning unit 102-2 trains the chain model that models the chain pattern representing the characteristic of the occurrence order of the probabilistic models M (step S302). The learning unit 102-2 may acquire learning data containing information indicating the order of the probabilistic models from an external device or the like, and use such learning data to train the chain pattern.

The learning unit 102-2 stores the trained K probabilistic models and the trained chain model in the storage unit 121-2 (step S303), and ends the learning processing.

Next, diagnosis processing performed by the information processing device 100-2 according to the second embodiment will be described. The present embodiment is different from the first embodiment in respect that it takes into account the similarity with respect to the chain model when calculating the similarity. In the diagnosis processing illustrated in FIG. 5, the processing of calculating the similarity at step S203 is modified. The flow of processing other than step S203 is the same as in the first embodiment, so the explanation is omitted.

For example, the similarity calculation unit 103-2 first calculates the similarity SB between each of the pieces of partial time series data starting from within the matching range and contained in the target time series data x and each of the probabilistic models contained in the probabilistic model group. The similarity calculation unit 103-2 calculates, for the time series data for which the similarity SB is calculated, the similarity SC between the chain model and the pieces of partial time series data occurring consecutively. The similarity calculation unit 103-2 calculates the similarity SA by an operation of the similarity SB and the similarity SC.

In this manner, the second embodiment can detect an anomaly based on the time series data by also taking into account the chain model that models the occurrence order of the probabilistic models.

As described above, the first and second embodiments can execute detection of the state based on time series data with higher accuracy.

Next, the hardware configuration of the information processing device according to the first or second embodiment will be described by referring to FIG. 9. FIG. 9 is a diagram illustrating an example of the hardware configuration of the information processing device according to the first or second embodiment.

The information processing device according to the first or second embodiment includes a control device such as a Central Processing Unit (CPU) 51, memory devices such as a Read Only Memory (ROM) 52 and a Random Access memory (RAM) 53, a communication I/F 54 that is connected to a network for performing communication, and a bus 61 that connects each of the units.

The computer program to be executed by the information processing device according to the first or second embodiment is provided by being loaded in advance in the ROM 52 or the like.

The computer program to be executed by the information processing device according to the first or second embodiment may be recorded in an installable or executable format file on a computer readable recording medium such as a Compact Disc Read Only Memory (CD-ROM), a flexible disk (FD), a Compact Disc Recordable (CD-R), a Digital Versatile Disc (DVD), or the like, and may be provided as a computer program product.

Furthermore, the computer program to be executed by the information processing device according to the first or second embodiment may be stored on a computer connected to a network such as the Internet and may be provided by being downloaded via the network. The computer program executed by the information processing device according to the first or second embodiment may also be provided or distributed via a network such as the Internet.

The computer program executed by the information processing device according to the first or second embodiment may cause the computer to function as each of the units of the information processing device described above. As for the computer, the CPU 51 can read the computer program from a computer-readable storage medium and execute it on the main memory.

Configuration examples of the embodiments are described below:

### Configuration Example 1

An information processing device including:
one or more hardware processors configured to
calculate first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determine a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

### Configuration Example 2

The information processing device according to Configuration Example 1, wherein each of the plurality of probabilistic models is a multidimensional probability distribution model defined using a mean and a variance and with the specific value as a number of dimensions.

### Configuration Example 3

The information processing device according to Configuration Example 2, wherein the one or more hardware processors are configured to use the mean and the variance to obtain a normal range where time series data is assumed to be normal, and output output information including the normal range.

### Configuration Example 4

The information processing device according to any one of Configuration Examples 1 to 3, wherein the one or more hardware processors extend the plurality of pieces of partial time series data to probabilistic models, and calculate values based on distances between the extended probabilistic models and the plurality of probabilistic models as the first similarities.

### Configuration Example 5

The information processing device according to any one of Configuration Examples 1 to 4, wherein the one or more hardware processors:
for each piece of first data contained in pieces of partial time series data, calculates second similarities with respect to the plurality of probabilistic models;
calculate third similarity between a chain model modeling a pattern of occurrence order of the plurality of probabilistic models and the pieces of partial time series data containing the first data, among the plurality of pieces of partial time series data; and
calculate the first similarities by an operation using the second similarities and the third similarity.

### Configuration Example 6

The information processing device according to any one of Configuration Examples 1 to 5, wherein the one or more hardware processors is configured to detect a state of the target time series data by using the first similarities included in the plurality of pieces of matching information.

### Configuration Example 7

The information processing device according to Configuration Example 6, wherein the one or more hardware processors detect that there is an anomaly in the target time series data, when a minimum value of the first similarities included in the plurality of pieces of matching information is smaller than a threshold.

### Configuration Example 8

The information processing device according to any one of Configuration Examples 1 to 7, wherein the one or more hardware processors is configured to train the plurality of probabilistic models by using a plurality of pieces of time series data for learning.

### Configuration Example 9

The information processing device according to any one of Configuration Examples 1 to 8, wherein the one or more hardware processors repeatedly execute, multiple times, processing of obtaining partial time series data whose first similarity with respect to any of the plurality of probabilistic models is maximum, among pieces of partial time series data each starting from one of a plurality of positions included in a range corresponding to the specific value from a position set immediately before among the positions, and determining matching information that includes the obtained partial time series data, a probabilistic model whose first similarity with respect to the obtained partial time series data is maximum, and a maximum first similarity, to output the plurality of pieces of matching information.

### Configuration Example 10

The information processing device according to any one of Configuration Examples 1 to 9, wherein the first probabilistic models are probabilistic models whose first similarities with respect to the plurality of pieces of partial time series data at the positions are maximum.

### Configuration Example 11

An information processing method executed by an information processing device, the information processing method including:
calculating first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determining a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

### Configuration Example 12

A computer program product including a computer-readable medium including programmed instructions, the instructions causing a computer to execute:
calculating first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determining a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to
calculate first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determine a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

2. The device according to claim 1, wherein each of the plurality of probabilistic models is a multidimensional probability distribution model defined using a mean and a variance and with the specific value as a number of dimensions.

3. The device according to claim 2, wherein the one or more hardware processors are configured to
use the mean and the variance to obtain a normal range where time series data is assumed to be normal, and
output output information including the normal range.

4. The device according to claim 1, wherein the one or more hardware processors
extend the plurality of pieces of partial time series data to probabilistic models, and
calculate values based on distances between the extended probabilistic models and the plurality of probabilistic models as the first similarities.

5. The device according to claim 1, wherein the one or more hardware processors:
for each piece of first data contained in pieces of partial time series data, calculate second similarities with respect to the plurality of probabilistic models;
calculate third similarity between a chain model modeling a pattern of occurrence order of the plurality of probabilistic models and the pieces of partial time series data containing the first data, among the plurality of pieces of partial time series data; and
calculate the first similarities by an operation using the second similarities and the third similarity.

6. The device according to claim 1, wherein the one or more hardware processors is configured to detect a state of the target time series data by using the first similarities included in the plurality of pieces of matching information.

7. The device according to claim 6, wherein the one or more hardware processors detect that there is an anomaly in the target time series data, when a minimum value of the first similarities included in the plurality of pieces of matching information is smaller than a threshold.

8. The device according to claim 1, wherein the one or more hardware processors is configured to train the plurality of probabilistic models by using a plurality of pieces of time series data for learning.

9. The device according to claim 1, wherein the one or more hardware processors repeatedly execute, multiple times, processing of obtaining partial time series data whose first similarity with respect to any of the plurality of probabilistic models is maximum, among pieces of partial time series data each starting from one of a plurality of positions included in a range corresponding to the specific value from a position set immediately before among the positions, and determining matching information that includes the obtained partial time series data, a probabilistic model whose first similarity with respect to the obtained partial time series data is maximum, and a maximum first similarity, to output the plurality of pieces of matching information.

10. The device according to claim 1, wherein the first probabilistic models are probabilistic models whose first similarities with respect to the plurality of pieces of partial time series data at the positions are maximum.

11. An information processing method executed by an information processing device, the information processing method comprising:
calculating first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determining a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.

12. A computer program product comprising a computer-readable medium including programmed instructions, the instructions causing a computer to execute:
calculating first similarities between a plurality of probabilistic models each modeling a probability of a value, at corresponding time, of time series data whose data length is a specific value, and a plurality of pieces of partial time series data whose data length is the specific value, the plurality of pieces of partial time series data being contained in target time series data to be a target of diagnosis; and
determining a plurality of pieces of matching information including positions of the plurality of pieces of partial time series data in the target time series data, first probabilistic models whose first similarities with respect to the plurality of pieces of partial time series data at the positions are larger than other probabilistic models, and the first similarities to the first probabilistic models.
